(19) United States
(12) Patent Application Publication
(10) Pub. No.: US 2009/0045545 A1
(43) Pub. Date: Feb. 19, 2009

(54) SOLUTION CASTING EQUIPMENT APPARATUS AND SOLUTION CASTING METHOD

(75) Inventors: Seiichi Ohno, Kanagawa (JP); Masataka Hasegawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/067,119

(22) PCT Filed: Sep. 19, 2006
(86) PCT No.: PCT/JP2006/318894

§ 371 Date: Mar. 17, 2008

(30) Foreign Application Priority Data
Sep. 20, 2005 (JP) 2005-272532

(51) Int. Cl. B29D 7/00; B28B 5/02

(52) U.S. Cl. 264/212; 425/224

(57) ABSTRACT

A casting belt 86 is produced of stainless steel. On a casting surface 86a on which a dope 61 is cast, two points P1, P2 arranged in the widthwise direction X of the casting belt 86 are determined, such that the length L between two points P1P2 may be 10 mm. When a depth between the top and the bottom of the surface unevenness might is continuously measured along the line P1P2, a depth maximum DE is at most 40 μm. Thus even if the film production is made for a long time, it is prevented that austenite partially transforms to martensite. Therefore, the scratches and deformations extending in the lengthwise direction hardly occur.

### TECHNICAL FIELD

The present invention relates to a solution casting apparatus and a solution casting method, especially a solution casting equipment for and a solution casting method of producing a polymer film to be used as a functional film of an electric material.

### BACKGROUND ART

A polymer film, such as a cellulose acylate film and the like, is often used for a polarizing filter, in an electronic display and so on, and produced by a solution casting method or a melt extrusion method. In the solution casting method, the produced film is excellent in smoothness, transparency and the like, and therefore a more excellent optical product can be obtained.

In the solution casting method, a dope is cast onto a continuously running support which is supported by plural rotary drums. Thus a casting film is formed on the support, peeled from the support and then dried to be a film. According to the support, if the thickness is not uniform, or if there is a wave-like deformation even with the uniformity of the thickness, the produced film has defects in planarity and smoothness. FIG. 4 is a sectional view of a support 201 with wave-like deformation in a prior art. FIG. 5 is a plan view of a film 203 obtained by casting a dope on the support 201 of FIG. 4. In FIG. 4, an arrow X shows a widthwise direction of the support 201, and in FIG. 5, arrows X & Y respectively show widthwise and lengthwise directions of the film 203. In FIG. 4, the support 201 of the prior art has in a widthwise direction the non-uniform thickness or a wave-like deformation with the uniform thickness. If the support 201 is used, the obtained film 203 has stripe-like deformations 204 in the lengthwise direction. If the support 201 has in the lengthwise direction a non-uniform thickness or a wave-like deformation with the uniform thickness, the obtained film has stripe-like deformations in the widthwise direction.

Therefore, it is necessary for the support to have both of the uniform thickness and the planarity. If order to satisfy this requirement, a rear face of the support, namely a surface contacting to the drum (and without contacting to the dope) must be smooth.

By the way, there are some proposition of the solution casting methods and the solution casting devices, in which the deformation of the film is reduced and the film thickness is made uniform. For example, as described in Japanese Patent Laid-Open Publication No. 2002-273747, the dope is cast onto a casting belt as the support running in an upward side between paired drums, and a control is made such that a belt length may have a relation to temperatures of the casting belt at the respective contacting points. Thus the running of the casting belt as the support is stably made without meandering, such that the produced film may have high quality. Further, as described in Japanese Patent Laid-Open Publication No. 2002-307460, a plurality of back-up rollers for supporting the casting belt between the paired drums is disposed, and the distance between the rollers is at most 5 m. Thus the vibration of the casting belt is reduced. Further, in Japanese Patent Laid-Open Publication No. 2003-1654, the paired drums contact to a rear surface of the casting belt, and the vibration in up- and downwards of each contacting point of the casting belt to the back-up roller is reduced in 100 μm. Thus the slight vibration of the endless belt for casting the dope is also reduced, such that the fluctuation of the film thickness may be reduced. Furthermore, in Japanese Patent Laid-Open Publication No. 2003-25352, the back-up rollers for supporting the rear surface of the casting belt are tendency drive roller, and disposed in the up- and downside of the casting belt between the paired drums.

However, when the support is used for a long time, the quality thereof changes, and an apparatus and a method for producing the film stably for a long time are not supposed. Especially, there are no suppositions to reduce the change of the quality of the support in use for a long time such that the occurrence of the stripe-like deformation and other deformation of the film may be reduced for a long time.

An object of the present invention is to provide a solution casting apparatus and a solution casting method for reducing the change of the quality of the film such that the occurrence of the stripe-like deformation extending in the lengthwise direction of the film may be reduced.

### DISCLOSURE OF INVENTION

In order to achieve the objects and other objects of the present invention, a solution casting apparatus of the present invention comprising a casting die for casting a dope, and a continuously running metal support having a casting surface on which the cast dope forms a casting film. When tow points are determined on the casting surface so as to be 10 mm apart in a widthwise direction of the metal support, a depth maximum DE between a top and a bottom of a surface unevenness of the casting surface is at most 40 μm between the two points.

Preferably, a compressive residual stress of the metal support is at most 500 MPa.

Preferably, the metal support is an endless belt. Particularly preferably, the solution casting apparatus further includes a pair of back-up rollers for supporting the endless belt and a shift device for shifting at least one of the back-up rollers so as to control a tension of the endless belt in the running direction. The endless belt circulatory runs in accordance with rotation of at least one of the back-up rollers. Especially preferably the tension of the endless belt is in the range of 50 N/mm² to 200 N/mm². Further, it is preferable that the endless belt is produced of stainless steel, and the annealing is performed to the endless belt.

In a solution casting method of the present invention, a dope is cast onto a casting surface of a continuously running metal support so such that a casting film may be formed. The casting film is peeled as a film from the metal support. When two points apart from 10 mm in a widthwise direction of the metal support is determined on the casting surface of the metal support, a depth maximum DE between a top and a bottom of a surface unevenness of the casting surface is at most 40 μm between the two points.

Preferably, a compressive residual stress of the metal support is at most 500 MPa.

Preferably, the metal support is an endless belt supported by a pair of back-up rollers, and the endless belt is circulatory runs in accordance with rotation of the back-up rollers. Particularly preferably, in the solution casting method, at least one of the back-up rollers is shift by a shift device so as to control a tension of the endless belt in the running direction. Especially preferably, the tension of the endless belt is in the range of 50 N/mm² to 200 N/mm². Further, it is preferable that the endless belt is produced of stainless steel, and the annealing is performed to the endless belt.

According to the invention, the change of the quality by the use of the support for the long time is reduced, and therefore, the stripe-like deformation and the other deformation are reduced for a long time.

### BRIEF DESCRIPTION OF DRAWINGS

FIG. 1 is a schematic diagram of a dope production apparatus of the present invention;

FIG. 2 is a schematic diagram of a solution casting apparatus for producing a polymer film of the present invention;

FIG. 3 is a cross-sectional view of a casting belt in a widthwise direction thereof;

FIG. 4 is a cross-sectional view of a casting belt in a widthwise direction thereof in a prior art;

FIG. 5 is an explanatory view of a film produced by a solution casting apparatus of a prior art;

### BEST MODE FOR CARRYING OUT THE INVENTION

As polymer in this embodiment, cellulose acylate is used and especially preferably triacetyl cellulose (hereinafter TAC). However, except of cellulose acylate, there are other polymers to be used to form a polymer film by the solution casting method, and the other polymers can be applied to the present invention. As for cellulose acylate, it is preferable that the degree of substitution of acyl groups for hydrogen atoms on hydroxyl groups of cellulose preferably satisfies all of following formulae (I) —(III).

2.5≦A+B≦3.0 (I)

0≦A≦3.0 (II)

0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 mass % of TAC is particles having diameters from 0.1 mm to 4 mm. However, the polymer to be used in the present invention is not restricted in cellulose acylate.

A glucose unit constructing cellulose with β-1, 4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.8, and especially at least 0.85. When these sorts of cellulose acylate are used, a solution (or dope) having excellent solubility can be produced. Especially in non-chlorine type organic solvent is excellent in solubility and used for preparing the dope which has low viscosity and filterability.

Cellulose as a raw material of cellulose acylate may be obtained from linter cotton or pulp cotton. However, the preferable cellulose acylate is obtained from linter cotton.

In cellulose acylate, the acyl group having at least 2 carbon atoms may be aliphatic group or aryl group, and is not restricted especially. Such cellulose acylate is, for example, alkylcarbonyl ester and alkenylcarbonyl ester of cellulose. Further, there are aromatic carbonyl ester, aromatic alkyl carbonyl ester, or the like, and these compounds may have other substituents. As preferable examples of the compounds, there are propionyl group, butanoyl group, pentanoly group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

The detail explanation of cellulose acylate is made from [0140] to [0195] in Japanese Patent Laid-Open Publication No. 2005-104148. The description of this publication is also applied to the present invention.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and especially dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbon atoms, and alcohols having 1 to 12 carbon atoms are preferable, and a mixture thereof can be used, and for example, there is a mixture of methyl acetate, acetone, ethanol and n-butanol. These ethers, ketones, esters and alcohols may have the ring structure. Further, the compounds having at least two of functional groups (namely, —O—, —CO—, —COO— and —OH) in ethers, ketones, esters and alcohols can be used for the solvent.

The additives (such as the solvent, plasticizer, deterioration inhibitor, UV absorbing agent, optically anisotropic controller, retardation controller, dyne, matting agent, release agent, releasing accelerator and the like) are described in detail from [0196] to [0516] of Japanese Patent Laid-Open Publication No. 2005-104148.

[Dope Production Method]

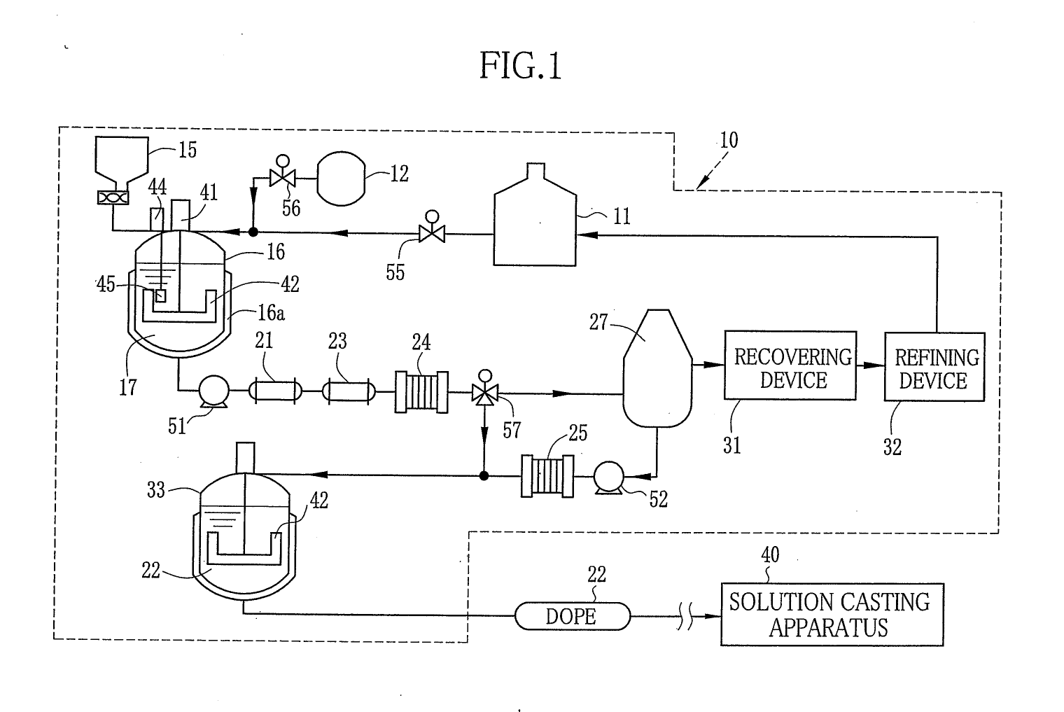

A dope production apparatus and a dope production method will be explained in reference with FIG. 1. However, the following explanation will describe only an example of the present invention, and therefore the present invention is not restricted in the embodiment. A dope production apparatus 10 is constructed of a first tank 11 for storing a solvent, an second tank 12 for storing an additive, a hopper 15 for supplying the TAC, and a third tank 16 for mixing the TAC and the solvent therein. Further, there is a heating device 21 for heating a mixture liquid 17 (described below in detail), a temperature controlling device 23 for controlling the temperature of the mixture liquid 17 such that a prepared dope may be obtained. Further, there are a flushing device 27 for concentrating the dope and a filtration device 25 for filtrating the concentrated dope.

Further, there are a recovering device 31 for recovering a solvent vapor, and a refining device 32 for refining and recycling the recovered solvent. The dope production apparatus 10 is connected through a stock tank 33 for storing a casting dope 22.

The third tank 16 is provided with a jacket 16a covering over an outer surface of the third tank 16, a first stirrer 42 to be rotated by a motor 41, and a second stirrer 45 to be rotated by a motor 44. The first stirrer 42 preferably has an anchor blade, and the second stirrer 45 is preferably an eccentric stirrer of a dissolver type. Further, the dope production apparatus 10 has first and second feed pumps 51, 52 and valves 55-57. Further, the valve 57 is a three dimensional valve. The positions, the number, the form and the like of the pumps and the valves are changed adequately.

In the dope production apparatus 10, the casting dope 22 is produced in the following order. The solvent in the first tank 11 and the TAC in the hopper 15 are sent to the third tank 16. Thereafter, a valve 56 is opened such that the additive in the second tank 12 may be sent to the third tank 16, in the situation that the additive compounds are dissolved or dispersed to the solvent. Although the solvent of the additive is usually the same as that of the first tank 11, the solvent may be changed depending on the sort of the additive.

Further, the method of feeding the additive to the third tank is not restricted in the above description. If the additive is in the liquid state in the room temperature, it may be fed in the liquid state to the third tank 16 without preparing for the additive solution. Otherwise, if the additive is in the solid state in the room temperature, it may be fed in the solid state to the third tank 16 with use of a hopper. If plural sorts of additive compounds are used, the additive containing the plural additive compounds may be accumulated in the second tank 12 altogether. Otherwise plural second tanks may be used so as to contain the respective additive compounds, which are sent through independent pipes to the third tank 16.

In the above explanation, the solvent, the TAC, and the additive are sequentially sent to the third tank 16. However, the sending order is not restricted in it. For example, after the predetermined amount of the TAC is sent to the third tank 16, the feeding of the predetermined amount of the solvent and the additive may be performed to obtain a TAC solution. Otherwise, it is not necessary to feed the additive to the third tank 16 previously, and the additive may be added to a mixture of TAC and solvent in following processes, in considering of the sort and characteristics of the additive.

The inner temperature in the third tank 16 is controlled by a heat transfer medium in the jacket 16a. The preferable inner temperature is in the range of −10° C. to 55° C. The solubility of the cellulose acylate can be adjusted depending on the type of the first and second stirrers 42, 45, the sort of cellulose acylate, the sort of the solvent and the like. In this embodiment, the dissolution of the mixture of the TAC, the solvent and the additive in a mixture liquid 17 is made such that the TAC may be swollen in the solvent.

A pump 51 is driven such that the mixture liquid 17 in the third tank 16 may be sent to the heating device 21 which is preferably a pipe with a jacket. Thus the dissolution of TAC proceeds Further, the temperature of the mixture liquid 17 is preferably in the range of 0° C. to 97° C. Therefore, the heating doesn't mean the increase of the temperature over the room temperature, but means only the increase of the temperature of the mixture liquid 17 fed out from the third tank 16. For example, if the temperature of the mixture liquid fed out from the third tank 16 is −7° C., the temperature after the heating of this embodiment may be 0° C. and the like. The heating device 21 may be preferably provided with a pressuring device so as to progress the dissolution effectively.

Instead of the heat-dissolution with use of the heating device 35, the mixture liquid 17 may be cooled in the range of −100° C. to −10° C. so as to perform the dissolution, which is already known as the cool-dissolution method. In this embodiment, one of the heat-dissolution and cool-dissolution methods can be chosen in accordance with the properties of the materials, so as to control the solubility.

The heated mixture liquid 17 is sent to a temperature controlling device 23 to control the temperature of the mixture liquid 17 nearly to a room temperature. From the temperature controlling device 23 is fed out the mixture liquid 17 as the dope in which the polymer is dissolved. However, the TAC is usually dissolved completely when fed out from the heating device 21.

Then the filtration of the dope is made in the filtration device 24, such that impurities and undissolved materials may be removed from the dope. The filter material of the filtration device 24 preferably has an averaged nominal diameter of at most 100 μm. The flow rate of the filtration in the filtration device 24 is preferably at least 50 liter/hr. The dope after the filtration is fed through a valve 57 and thus stored as a casting dope 22 in the stock tank 33.

The dope can be used as the casting dope 22 for a film production, which will be explained. However, in the method in which the dissolution of TAC is performed after the preparation of the swelling liquid, if it is designated that a dope of high concentration is produced, the time for production of such dope becomes longer. Consequently, the production cost becomes higher. Therefore, it is preferable that a dope of the lower concentration than the predetermined value is prepared at first and then the concentrating of the dope is made. In this embodiment, the dope after the filtration is sent to the flushing device 27 through the valve 57. In the flushing device 27, the solvent of the dope is partially evaporated. The solvent vapor generated in the evaporation is condensed by a condenser (not shown) to a liquid state, and recovered by the recovering device 31. The recovered solvent is refined and recycled by the refining device 32 and reused. According to this method, the decrease of cost can be designated, since the production efficiency becomes higher and the solvent is reused.

The dope after the concentrating as the above description is extracted from the flushing device 27 through a pump 52. Further, in order to remove bubbles generated in the dope, it is preferable to perform the bubble removing treatment. As a method for removing the bubble, there are many methods which are already known, for example, an ultrasonic irradiation method and the like. Then the dope is fed to the filtration device 24, in which the undissolved materials are removed. Note that the temperature of the dope in the filtration device 24 is preferably in the range of 0° C. to 200° C. The dope after the filtration is stored as the casting dope 22 in the stock tank 33, which is provided with the first stirrer 42 rotated by a motor 80. The first stirrer 42 is rotated so as to continuously stir the casting dope 22.

Thus a dope produced the produced dope preferably has the TAC concentration in the range of 5 mass % to 40 mass %, particularly 15 mass % to 30 mass %, and especially 17 mass % to 25 mass %. Further, the concentration of the additive (mainly plasticizer) is preferably in the range of 1 mass % to 20 mass %, if the solid content in the casting dope 22 is 100 mass %.

Note that the method of producing the casting dope 22 is disclosed in detail in [0517] to [0616] in Japanese Patent Laid-Open Publication No. 2005-104148, for example, the dissolution method and the adding methods of the materials, the raw materials and the additives in the solution casting method for forming the TAC film, the filtering method, the bubble removing method, and the like.

[Solution Casting Method]

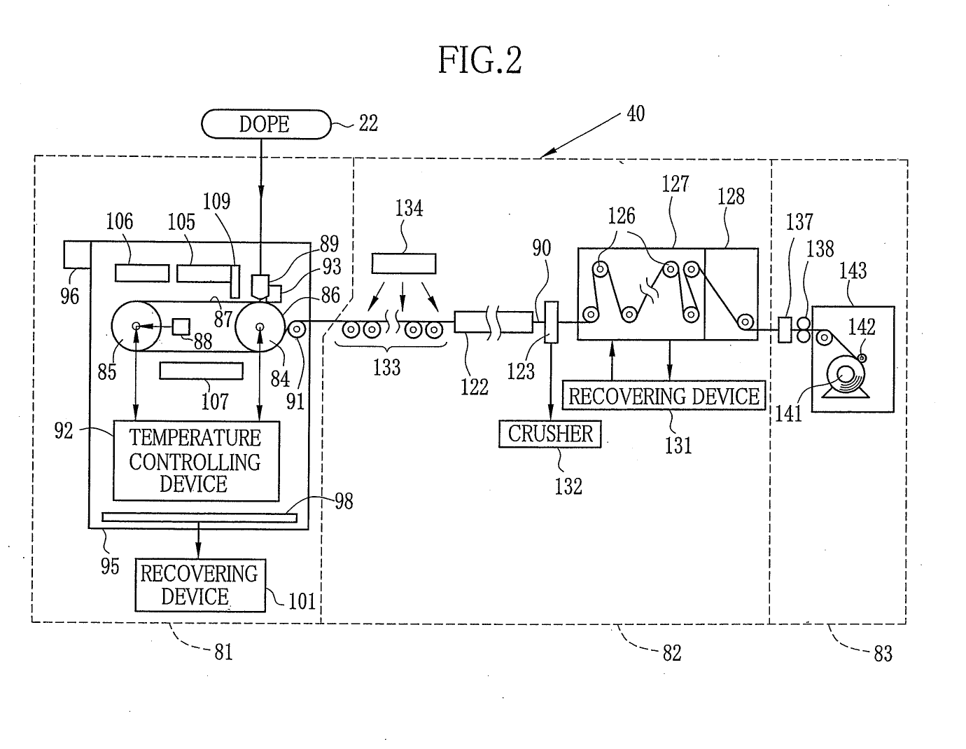

An embodiment of the solution casting method will be described in reference with FIG. 2, now. However, the present invention is not restricted in the embodiment. As shown in FIG. 2, a solution casting apparatus 40 includes a casting section 81 for casting the casting dope 22, a drying section 82 for drying a film 90 fed out from the casting section 81, and a winding section 83 for winding the dried film 90. However, these sections are not clearly partitioned in the solution casting apparatus 40.

The casting section 81 has a casting chamber 95 which includes back-up rollers 84, 85, and a casting belt 86 supported by the back-up rollers 84, 85. The casting belt 86 continuously runs in accordance with the rotation of the back-up rollers 84, 85. Furthermore, the casting section 81 has a shift device 88 for shifting the back-up roller 85 so as to control a tension of the casting belt 86, a casting die 89 for casting the dope 61 onto the casting belt 86 so as to form a casting film 87, and a peel roller for peeling the casting film 89 as the film 90 and supporting the film 90. The back-up rollers 84, 85 are connected with a heat transfer medium circulator 92 for circulatory feeing a heat transfer medium to the back-up rollers 84, 85 such that the surface temperatures of the back-up rollers 84, 85 may be constant. Further, the cast dope 22 forms a bead between the casting die 89 and the casting belt 86. In order control the pressure in an upstream side of the bead, it is preferable to dispose a decompression chamber 93 for making the decompression of the rear side from the bead. Further, in the solution casting apparatus 40, there is a heating device 94 for heating the casting belt 86.

A temperature controlling device 92 is provided for controlling the inner temperature of the casting chamber 95 to the predetermined value and a condenser 98 for condensing organic solvent evaporated in the casting chamber 95. Further a recovering device 101 for recovering the condensed organic solvent outside the casting chamber 95.

Further, the casting chamber 95 is provided with air blowers 105-107 for feeding airs toward the casting film 87. The air blower 105 is disposed in an upper and upstream side of the casting belt 86, and an air blower 106 in an upper and downstream side. Further, the air blower 107 is disposed in an downstream side. Further, the entrained air occurs in accordance with the running of the casting belt 86. Therefore, in the downstream from the casting die 89 near the casting belt 86, there is an air shielding member 109 for reducing the entrained air.

The materials of the casting die 89 are preferably double-phase stainless steel having a mixture composition of austenite phase and ferrite phase. The preferable material has coefficient of thermal expansion of at most 2×10⁻⁵ (° C.⁻¹). Further, the material to be used has an anti-corrosion property, which is almost the same as SUS316, in the examination of forcible corrosion in the electrolyte solution. Preferably, the materials to be used for the casting die 22 has such resistance of corrosion that the pitting doesn't occur on the gas-liquid interface even if the material is dipped in a mixture of dichloromethane, methanol and water for three months. The casting die 89 is preferably manufactured by performing the grinding after a month from the material casting. Thus the surface condition of the dope flowing in the casting die 89 is kept uniform. The finish precision of a contact face of the casting die to dope 22 is at most 1 μm in surface roughness and at most 1 μm/m in straightness. The clearance of a slit of the casting die 89 is automatically adjustable in the range of 0.5 mm to 3.5 mm. According to an edge of the contact portion of a lip end of the casting die 89 to the dope, R(R is chamfered radius) is at most 50 μm in all of a width. Further, the shearing rate in the casting die 89 is controlled in the range of 1 to 5000 per second.

A width of the casting die 89 is not restricted especially. However, the width is preferably at least 1.1 times and at most 2.0 times as large as a film width. Furthermore, the casting die 89 is preferably a coat hanger type die. Further, in order to adjust a film thickness, the casting die 89 is preferably provided with an automatic thickness adjusting device. For example, thickness adjusting bolts (heat bolts) are disposed at a predetermined distance in a widthwise direction of the casting die 89. According to the heat bolts, it is preferable that the profile is set on the basis of a predetermined program, depending on feed rate of pumps (preferably, high accuracy gear pumps), while the film production is performed. Further, the solution casting apparatus 40 may be provided with a thickness meter (not shown), such as infrared ray thickness meter and the like. In this case, the feed back control of the adjustment value of the heat bolts may be made by the adjusting program on the base of the profile of the thickness meter. The thickness difference between any two points in the widthwise direction except the side edge portions in the casting film is controlled preferably to at most 1 μm. The difference between the maximum and the minimum of the thickness in the widthwise direction is at most 3 μm, and especially at most 2 μm. Further, the accuracy to the designated object value of the thickness is preferably in ±1.5 μm.

Preferably, a hardened layer is preferably formed on a top of a lip end of the casting die 89. A method of forming the hardened layer is not restricted. But it is, for example, ceramics hard coating, hard chrome plating, nitriding processing, and the like. If ceramics is used as the hardened layer, it is preferable that the used ceramics is grindable but not friable, with a lower porosity, high resistance of corrosion, and poor adhesiveness to the casting die 89. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of the casting dope 22 flowing on slit ends of the casting die 89, it is preferable to provide a solvent supplying device (not shown) at the slit ends, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The supply rate to each slit end is preferably in the range of 0.1 mL/min to 1.0 mL/min, in order to prevent the foreign materials from mixing into the casting film. Note that the pump for supplying the solvent has a pulse rate (or ripple factor) at most 5%.

The width, the length and the material of the casting belt 86 are not restricted especially. However, it is preferably 1.05 to 1.5 times as large as the casting width. Preferably, the length is from 20 m to 200 m, and the thickness is from 0.5 mm to 2.5 mm. The casting belt 86 is usually made of metal alloy of stainless steel, in which chromium (Cr) was added into iron (Fe) as substrate. In order to make the casting belt 86, a Cr passivation was made on a surface of the stainless steel belt, such that the produced casting belt 86 may have a corrosion resistance. Further, the preferable stainless steel for the casting belt 86 has a crystalline structure of austenite type. However, in consideration of the data obtained by the metallographic analysis with use of X-ray diffraction analyzer, a martensitic transformation occurs, namely an austenite partially transforms to martensite, while the casting is continuously made. The reason therefor is that the unevenness of the casting belt 86 is large, or that the residual stress is too large. Further martensite is easily abraded and removed, since the larger hardness and the lower corrosion resistance than the austenite. If martensitic transformation partially occurs in the casting belt 86, the produced film often has surface defects. Therefore, the casting belt 86 to be used in the present invention is as follows.

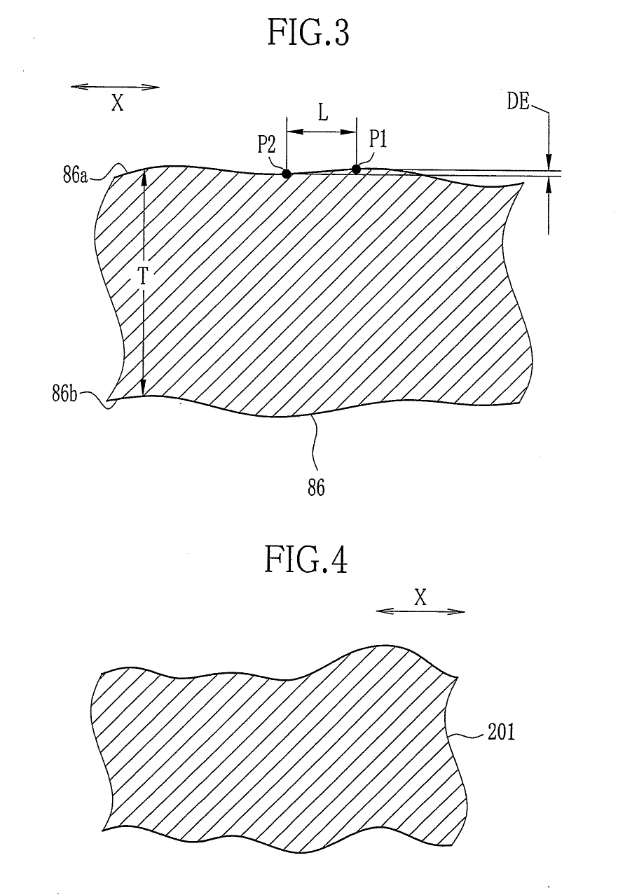

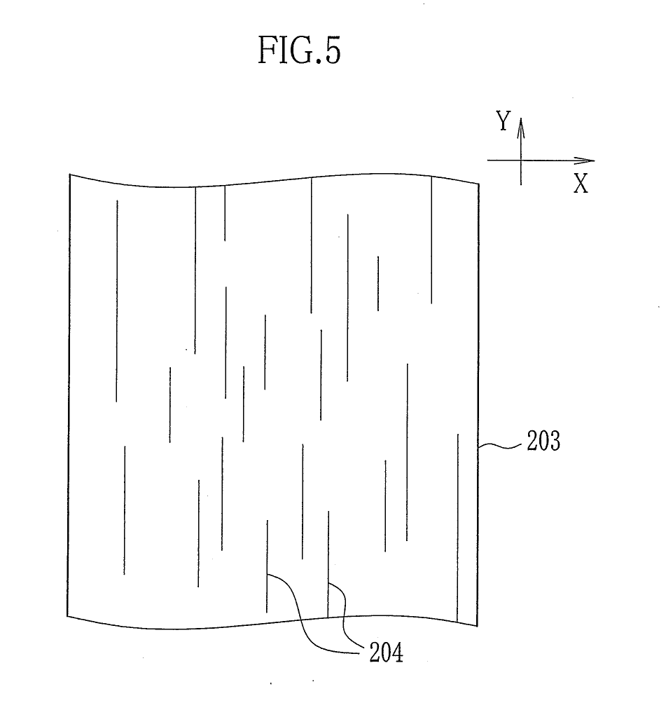

In FIG. 3, the arrow X is the widthwise direction of the casting belt 86. The casting belt 86 has a casting surface 86a on which the casting film 87 (see, FIG. 2) is to be formed, and a rear surface 86b contacting to the back-up rollers 84, 85. On the casting surface 86a, two points P1, P2 arranged in the widthwise direction X of the casting belt 86 are determined, such that the length L between the two points P1P2 may be 10 mm. A depth maximum DE between the top and the bottom of the surface unevenness might be at most 40 μm on the line P1P2. Thus the surface defect extending in the lengthwise direction on the produced film 90 is prevented from occurring so much in a small distance. If the depth maximum DE between the two points P1P2 of L=10 mm is larger that 40 μm, martensitic transformation occurs, namely an austenite partially transforms to martensite. Thus the produced film often has the long surface defect extending in the lengthwise direction. The casting surface 86a is preferably smooth, namely the depth maximum DE between the top and the bottom of the surface unevenness is nearly zero. Note that the existence of martensite can be detected easily by ferrite meter sold in the market.

However, even if the casting surface is smooth, the non-smoothness of the rear surface 86b also causes the change of the distance of the casting surface 86a from the casting die 89 in the running of the casting belt 86, and therefore the surface defect of the produced film 90 occurs. Therefore, it is preferable that the rear surface 86b of the casting belt 86 is also smooth. Preferably, the nonuniformity of the thickness T of the casting belt 86 is at most 20 μm.

Preferably, the materials for the casting belt 86 is different in the hardness from that of the back-up rollers 84, 85. If the casting belt 86 and the back-up rollers 84, 85 have the same hardness, the friction between them causes the abrasion, and therefore the abrasion powders of the casting belt 86 sometimes occur.

Preferable is the smaller compressive residual stress. However, it is difficult to produce the casting belt 86 such that the compressive residual stress may be zero. Therefore, in the present invention, it is preferable that the compressive residual stress is at most 500 MPa. Thus the effect for reducing the martensitic transformation becomes larger, and therefore the surface defect of the film is reduced. Note that the measurement of the compressive residual stress can be performed by an X-ray diffraction analyzer or a neutron diffraction analyzer.

The casting belt 86 described above is, for example, produced by rolling the stainless steel to a continuous plate, connecting the front and back ends thereof to each other to be a continuous stainless belt, and grinding both surfaces. In the grinding, there are two processes. In the first process, a first grinding is made with use of a grinder and the like, while the continuous stainless belt is running in accordance with a paired back-up rollers. Thereafter, in the second process, a second grinding is made with use of a grind wheel, such that the casting surface 86a may be a mirror surface. Further, the annealing is performed such that the compressive residual stress may be at most 500 MPa. The preferable stainless steel is SUS316 and SUS304, and especially SUS316, such that the produced casting belt 86 may have an enough resistance to corrosion and strength.

Preferably, the surface defect of the casting belt 86 is reduced to be minimal. Concretely there are no pin hole of at least 30 μm, at most one pin hole in the range of 10 μm to 30 μm, and at most two pin holes of less than 10 μm per 1 m².

In the drying section 82, there is a transfer area 133 and a tenter device 122, an edge slitting device 123, a drying chamber 127 and a cooling chamber 128. In the transfer area 133, an air blower 134 feed out an air toward the film 90 so as to dry it. After the transfer in the transfer area 133, the tenter device 122 dries and simultaneously stretches the film 90 in a predetermined direction. Thereafter, the edge slitting device 123 slits off both side edge portions of the film 90 into tips, and the tips of both side edge portions are crushed by a crusher 132 which is connected to the edge slitting device 123.

In the drying chamber 127, the film 90 is transported with lapping on rollers 126. The solvent vapor evaporated from the film 90 by the drying chamber 127 is adsorbed and recovered to the mixture solvent by a recovering device 131. The film 90 is transported into the cooling chamber 128, and cooled down.

Thereafter, in the winding section 83, there is a compulsory neutralization device (or a neutralization bar) 137 for eliminating the charged electrostatic potential of the film 90 to the predetermined value, and a knurling roller 138 for making the embossing to both edge portions of the film 90, and a winding roller 141 for winding the film 90. At the winding, a tension is applied at the predetermined value to the film 90 by a press roller 142.

Further, the heating device (not shown) feeds out a heat air toward the rear surface contacting of the casting belt 86 to the back-up rollers 84, 85. Thus the drying of the casting film 74 is made on the rear side. However, the heating device 94 is not restricted in this embodiment, and may be a heat controller and the like, such as a device in which a temperature of a periphery can be adjustable. The heating device is provided with a temperature controller (not shown), and there is a temperature sensor (not shown) foe sensing the temperature of the casting belt 86 without contact closely thereto. On the basis of the sensing by the temperature sensor, the temperature controller makes the temperature control of the heating device.

Then the solution casting method performed by the solution casting apparatus 40 will be described in followings. The back-up roller 85 (in the downstream side from the casting die 89) is rotated by a driver (not shown). Thus the casting belt 86 endlessly runs. The casting speed in preferably in the range of 10 m/min to 200 m/min. The position of the back-up rollers 84, 85 is adjusted by the shift device 88, such that the tension to the casting belt 86 in the running direction is preferably in the range of 25 N/mm² to 200 N/mm², and particularly 50 N/mm² to 100 N/mm². If the tension is less than 25 N/mm², the tension is not enough, which causes the meandering of the casting belt 86. If the tension is more than 200 N/mm², the abrasion is caused by the contact to the back-up rollers 84, 85. Preferably, the meandering of the casting belt 86 running for one cycle is reduced in 1.5 mm. Preferably, a detector (not shown) for detecting the positions of both side portions of the casting belt 86 is provided, and the feed back control of the positions of the casting belt 86 is made on the basis of the data obtained by the detector. Further, the relative speed between the casting belt 86 and the back-up rollers 84, 85 is preferably at most 0.01 m/min. The variation of the speed of the casting belt 86 is controlled to at most 0.5% to the predetermined value. Further, below the casting die 89, the variation of the position in the vertical direction between the lip end of the casting die and the casting belt 86 was in 200 μm.

The casting dope 22 is cast from the casting die 89 onto the casting belt 86, so as to form the casting film 89.

In order to stabilize the formation of a bead of the cast dopes, the pressure control in the back side of the bead is made by the decompression chamber 93. Preferably, the decompression is made such that the pressure of the back side may be 5 Pa to 1000 Pa lower than that of the front side. It is preferable to provide the decompression chamber 93 with a jacket (not shown) for controlling the inner temperature. The temperature of the decompression chamber 93 is not restricted especially. However, the temperature is preferably in the range of 25° C. to 55° C. Further, aspirators (not shown) may be provided with the decompression chamber 93 so as to be near both side edges of a dope outlet of the casting die 89. Thus the aspiration in both side edges of the bead is made to stabilize the shape of the bead. In this case, the force velocity of the aspiration is preferably in the range of one to one hundred Litter/min.

The temperature of the back-up rollers 84, 85 is controlled with use of the heat transfer medium circulator 92. By the heat transfer from the back-up rollers 84, 85, the surface temperature of the casting belt 86 is controlled in the range of −20° C. to 40° C. Note that paths (not shown) of the heat transfer medium are provided in the back-up rollers 84, 85. The heat transfer medium whose temperature is controlled by the heat transfer medium circulator 92 is fed through the paths, such that the temperature of the back-up rollers 84, 85 are kept to predetermined values.

The organic solvent compounds evaporated from the casting film 87 is condensed by the condenser 98, and the condensed compounds are recovered by the recovering device 101 and reused for the solvent for the dope production.

At the casting, the temperature in the casting chamber 95 is preferably controlled in the range of −10° C. to 57° C.

In the transfer area 133, while the film 90 is transferred with use of the pass rollers, a drying air is fed from the air blower to dry the film 90, such that the drying may proceed. Preferably, the temperature of the drying air is in the range of 20° C. to 250° C. Note in the transfer area 133 that the rotating speed of the pass roller may be set to be higher in the downstream side, so as to draw the film 90.

During the transportation in the tenter device 122, the film 90 is held by clipping both side edge portions, and at the same time the drying is made to evaporate the solvent. The tenter device 122 is preferably partitioned into several temperature areas of different temperatures, such that the drying is made under different drying conditions of the respective temperature areas. At the same time, the stretching of the film 90 in the widthwise direction may be made. In this case, in the transfer area 133 or/and the tenter device 122, the stretching in the widthwise direction and the drawing in the lengthwise direction are made such that the width and the length may be in the range of 0.5% to 300% larger than the original size.

The film 90 is dried until the content of the remaining solvent become the predetermined value, and fed out as the film 90 from the tenter device 122 toward the edge slitting device 123 for slitting off both side edge portions. The slit side edge portions are sent to the crusher 132 by a cutter blower (not shown), and crushed to tips by the crusher 132. The tips are reused for preparing the dope, which is effective in view of the decrease of the production cost. Note that the slitting process of both side edge portions may be omitted. However, it is preferable to perform the slitting between the casting process and the winding process.

The film 90 whose side edge portions are slit off is sent to the drying chamber 127 and dried furthermore. In the drying chamber 127, the film 90 is transported with lapping on the rollers 126. The inner temperature of the drying chamber 127 is not restricted especially. However, it is preferable in the range of 60° C. to 145° C. The solvent vapor evaporated from the film 90 by the drying chamber 127 is adsorbed by the recovering device 131. The air from which the solvent components are removed is reused for the drying air in the drying chamber 127. Note that the drying chamber 127 preferably has plural partitions for variation of the drying temperature. Further, a pre-drying chamber (not shown) is provided between the edge slitting device 123 and the drying chamber 127, so as to perform the pre-drying of the film 90. Thus it is prevented that the temperature of the film 90 increases rapidly, and therefore the change of the shape of the film 90 is reduced.

The film 90 is transported into the cooling chamber 128, and cooled therein to around the room temperature. A humidity control chamber (not shown) may be provided for conditioning the humidity between the drying chamber 127 and the cooling chamber 128. Preferably, in the humidity control chamber, an air whose temperature and humidity are controlled is applied to the film 90. Thus the curling of the film 90 and the winding defect in the winding process can be reduced.

Thereafter, a compulsory neutralization device (or a neutralization bar) 113 eliminates the charged electrostatic potential of the film 90 to the predetermined value (for example, in the range of −3 kV to +3 kV). The position of the neutralization process is not restricted in this embodiment. For example, the position may be a predetermined position in the drying section or in the downstream side from the knurling roller 114, and otherwise, the neutralization may be made at plural positions. After the neutralization, the embossing of both side portions of the film 90 is made by the embossing rollers to provide the knurling. The emboss height from the bottom to the top of the embossment is in the range of 1 μm to 200 μm.

In the last process, the film 90 is wound by a winding shaft 115 in a winding chamber 143. At this moment, a tension is applied at the predetermined value to the press roller 142. Preferably, the tension is gradually changed from the start to the end of the winding. In the present invention, the length of the film 90 is preferably at least 100 m. The width of the film is preferably at least 600 mm, and particularly in the range of 1400 mm to 1800 mm. Further, even if the width is more than 1800 mm, the present invention is effective. When it is designated to produce the film which is 15 μm to 100 μm in thickness, the present invention is also applied.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by or contained in lower-viscosity dopes. Concretely, it is preferable that the dopes for forming the surface layers have lower viscosity than the dope for forming a layer sandwiched by the surface layers. Further, when the co-casting is designated, it is preferable in the bead between a die slit (or die lip) and the support that the composition of alcohol is higher in the two outer dopes than the inner dope.

At the production of the film having the multi-layer structure, it is preferable to add a peeling accelerator to the one dope to be contacted to the casting belt 86. The peeling accelerator is added for peeling the casting film from the support, and may be compounds already known. Further, in both case of the single structure and multi-layer structure of the film, it is preferable to add a plasticizer in the range of 3 wt. % to 20 wt. % of the weight of the entire film, and the UV-absorbing agent in the range of 0.001 wt. % to 5 wt. %, and particles in the range of 0.001 wt. % to 5 wt. %.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The film 90 may be provided with an undercoating layer on at least one of the surfaces, and used in the several ways.

The obtained cellulose acylate film is used as a base film on which functional layers are formed. Thus several sorts of functional materials are obtained. The functional layers is at least one of antistatic layer, curable resin layer, antireflection layer, easy adhesive layer, antiglare layer and optical compensation layer.

These functional layers preferably contain at least one sort of surfactants in the range of 0.1 mg/m² to 1000 mg/m². Further, the functional layers preferably contain at least one sort of lubricants in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses from [1088] to [1265] the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

In followings, Examples of the present invention will be explained. However, the present invention is not restricted in it.

### EXAMPLE 1

### Composition

| | | |
|---|---|---|
| Cellulose Triacetate | 100 | pts. mass |
| (Powder: degree of substitution, 2.84; | | |
| viscosity-average degree of polymerization, | | |
| 306; water content, 0.2 mass %; viscosity | | |
| of 6 mass % dichloromethane solution, 315 | | |
| mPa · s; averaged particle diameter, 1.5 | | |
| mm; standard deviation of particle diameter, | | |
| 0.5 mm) | | |
| Dichloromethane (first solvent compound) | 320 | pts. mass |
| Methanol (second solvent compound) | 83 | pts. mass |
| 1-butanol (third solvent compound) | 3 | pts. mass |
| Plasticizer A (triphenylphosphate) | 7.6 | pts. mass |
| Plasticizer B (diphenylphosphate) | 3.8 | pts. mass |
| UV-agent A | 0.7 | pts. mass |
| (2(2′-hydroxy-3′,5′-di-tert- | | |
| butylphenyl)benzotriazol) | | |
| UV-agent B | 0.3 | pts. mass |
| (2(2′-hydroxy-3′,5′-di-tert- | | |
| amylphenyl)-5-chlorobenzotriazol) | | |
| Mixture of citric acid esters | 0.006 | pts. mass |
| (Mixture of citric acid, citric acid | | |
| monoethyl ester, citric acid dimethyl | | |
| ester, citric acid triethyl ester) | | |
| Particles | 0.05 | pts. mass |
| (particle diameter, 15 nm; Mohs Hardness, | | |
| about 7) | | |

[Cellulosetriacetate]

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton, and called cotton TAC in the following explanation.

(1-1) Preparation of Dope

The casting dope 22 was prepared in the dope production apparatus 10 of FIG. 2. The third tank 16 had first and second stirrers 42, 45 and was made of stainless and 4000 L in volume. Into the third tank, plural solvent compounds were mixed such that a mixture solvent was obtained. Note that the water content in each solvent compound is at most 0.5 mass %. The stirring was made with use of the first stirrer 42 having the anchor blade and the second stirrer 45 which was eccentric stirrer of dissolver type. At first, the first stirrer 42 performed the stirring at one m/sec as circumferential velocity, and the second stirrer 45 performed the stirring at shear rate at first 5 m/sec. Thus the dispersion was made for 30 minutes during the stirring. The dissolving started at 25° C., and the temperature of the dispersion became 48° C. at last. While the stirring of the mixture solvent was made, the cellulose triacetate flakes were added from the hopper 14 to the mixture solvent gradually, such that the total mass of the mixture solution and the cellulose triacetate flakes might be 2000 kg. After the dispersion, the high speed stirring (of the second stirrer 45) was stopped, and the stirring was performed by the first stirrer 42 at 0.5 m/sec as circumferential velocity for 100 minutes. Thus cellulose triacetate flakes was swollen such that the swelling liquid was obtained. Until the end of the swelling, the inner pressure of the third tank was increased to 0.12 MPa with use of nitrogen gas. At this moment, the hydrogen concentration in the third tank was less than 2 vol. %, which does not cause the explosion. Further, water content in the dope was 0.3 mass %.

(1-2) Dissolution & Filtration

The swelling liquid was fed to the heating device which is the tube with the jacket, and heated to 50° C., and thereafter heated under the application of pressure at 2 MPa to 90° C. Thus the dissolving was made completely. The heating time was 15 minutes. The temperature of the swelling liquid is decreased to 36° C. by the temperature controlling device 23, and then filtrated through the filtration device having filtration material whose nominal diameter was 8 μm. At this moment, the upstream side filtration pressure was 1.5 MPa, and the downstream side filtration pressure was 1.2 MPa. Since the filter, the housing and the pipes were made of hastelloy alloy and had jacket for using at high temperature, they were made from materials excellent in corrosion resistance.

(1-3) Concentration, Filtration, Defoaming & Additive

The dope was fed into the flushing device whose pressure was kept to the atmospheric pressure at 80° C., such that the flush evaporation of the dope was made. The solvent vapor was condensed by the condenser to the liquid state, and recovered by the recovering device 31. After the flushing, the content of solid compounds in the dope was 21.8 mass %. Note that the recovered solvent was recycled by the refining device 32 and reused. The anchor blade is provided at a center shaft of a flush tank of the flushing device 27, and the dope was stirred by the anchor blade at 0.5 m/sec as circumferential velocity. The temperature of the dope in the flush tank was 25° C., the retaining period of the dope in the flush tank was 50 minutes. Part of the dope was sampled, and the measurement of the shearing viscosity was made at 25° C. The shearing viscosity was 450 Pa·s at 10 (1/s) of shearing rate.

Then the defoaming was further made by irradiating very weak ultrasonic waves. Thereafter, the dope was fed to the filtration device by the pump under the application of pressure at 1.5 MPa. In the filtration device, the dope was fed at first through a sintered fiber metal filter whose nominal diameter was 10 μm, and then through the same filter of 10 μm nominal diameter. At the forward and latter filters, the upstream pressures were respectively 1.5 MPa and 1.2 MPa, and the downstream pressures were respectively 1.0 MPa and 0.8 MPa. The temperature of the dope after the filtration was controlled to 36° C., and stored as the casting dope 22 in the stainless stock tank 33 whose volume was 2000 L. The anchor blade is provided to a center shaft of the stock tank 33, and the casting dope 22 was always stirred by the first stirrer 42 of the anchor blade at 0.3 m/sec as circumferential velocity. Note that when the concentrating of the dope is made, corrosions of parts or portions contacting to the dope in the devices didn't occur at all.

Further, the mixture solvent A for preparing the additive liquid contained dichloromethane of 86.5 pts.mass, acetone 13 pts.mass, and 1-butanol 0.5 pts.mass.

(1-4) Discharging, Adding, Casting & Bead Decompression

The film is formed in the solution casting apparatus 40 shown in FIG. 2. The pump for increasing the upstream pressures was high accuracy gear pumps and driven to feed the casting dope 22 while the feed back control was made by an inverter motor. Thus the upstream pressure of high accuracy gear pump was controlled to 0.8 MPa. As for the pump, volumetric efficiency was 99.2%, and the variation rate of the discharging was at most 0.5%. Further, the discharging pressure was 1.5 MPa.

The width of the casting die 89 was 1.8 m, The flow rate of the casting dope 22 near a die lip of the casting die 89 is controlled such that the dried film may be 80 μm in thickness. The casting width of the casting dope 22 from the die lip was 1700 mm. T Further, in order to control the temperature of the casting dope 22 to 36° C., the casting die 89 was provided with a jacket (not shown), the temperature of the heat transfer medium to be supplied in the jacket was 36° C. at an entrance of the jacket.

The temperature of the casting die 89 and pipes was kept to 36° C. in the film production. The casting die 89 was the coat hunger type, in which heat bolts for adjusting the film thickness were disposed at the pitch of 20 mm. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the solution casting apparatus 40. Further, the average film thickness might was controlled in ±1.5%.

The upstream side of the casting die 89 is provided with the decompression chamber 93. The decompression rate of the decompression chamber 93 was controlled in accordance with the casting speed, such that the pressure difference might occur in the range of one Pa to 5000 Pa between the upstream and downstream sides of the bead of the cast dope above the casting die. At this time, the pressure difference between both side of a bead of the cast dope was determined such that the length of the bead might be from 20 mm to 50 mm. Further, an instrument was provided such that the temperature of the decompression chamber 93 might be set to be higher than the condensation temperature of the gas around the casting section. Further, there were labyrinth packings (not shown) in the upstream and downstream sides of the beads. Further, an opening was provided in both edges of the die lip of the casting die 89. Further, an edge suctioning device (not shown) for reducing the disturbance of the bead was provided for the casting die 89.

(1-5) Casting Die

The material of the casting die 89 was the precipitation hardening stainless steel, whose coefficient of thermal expansion was at most 2×10⁻⁵ (° C.⁻¹). In the compulsory corrosion experiment in an electrolyte solution, the corrosion resistance was almost the same as that of SUS316. Further, the material to be used for the casting die 89 had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die to the casting dope 22 was at most 1 μm in surface roughness, straightness in any direction was at most 1 μm in surface roughness, and the slit clearance of the die lip was adjusted to 1.5 mm. According to an edge of the contact portion of a lip end of the casting die 89, R is at most 50 μm in all of a width. Further, the shearing rate in the casting die 89 controlled in the range of one to 5000 per second. Further, the WC coating was made on the lip end from the casting die 89 by a melt extrusion method, so as to provide the hardened layer.

In order to prevent the dry and solidification on part of the slit end of the casting die 89, the mixture solvent A dissolvable of the solidified dope was supplied to each edge portion of the gas-liquid interface of the slit at 0.5 ml/min. Thus the mixture solvent is supplied to each bead edge. The pulse rate of a pump for supplying the mixture solvent was at most 5%. Further, the decompression chamber 93 was provided for decreasing the pressure in the rear side by 150 Pa. In order to control the temperature of the decompression chamber 93, a jacket (not shown) was provided, and a heat transfer medium whose temperature was controlled at 35° C. was supplied into the jacket. The edge suction rate could be controlled in the range of 1 L/min to 100 L/min, and was adequately controlled in this experiment so as to be in the range of 30 L/min to 40 L/min.

(1-6) Metal Support

The casting belt 86 was an endless stainless belt which was 2.1 m in width and 70 m in length. Further, as shown in FIG. 3, two points P1, P2 were determined in the widthwise direction X of the casting belt 86 on the casting surface 86a, such that the length L of the line P1P2 might be 10 mm. The casting surface was ground such that a depth maximum DE between the top and the bottom of the surface unevenness might be at most 20 μm along the line P1P2, and the thermal processing was made such that a compressive residual stress might be 100 MPa. The depth maximum DE was measured by Contour Measurement Contracer (produced by Mitsutoyo Corporation), or Profile Scanner (Tokyo Seimitsu Co., Ltd.). The measurement of the compressive residual stress and the metallographic analysis were performed by X-ray diffraction analyzer. Further, the thickness fluctuation in the widthwise direction was measured by a supersonic wave thickness gauge.

The casting belt 86 runs in accordance with the rotation of the back-up rollers 84, 85, and the rollers were adequately disposed for supporting the casting belt 86 on a passage of the running casting belt 86. The tension applied to the running casting belt 86 in the running direction was controlled so as to be 50 N/mm². The control of the tension was made on the basis of the shift of the back-up roller 84 and the relative speed of the back-up rollers 84, 85 to the casting belt 86. The measurement of the tension was made by a load cell, and a half of the measured value was determined as the tension applied to the casting belt 86. Further the variation of the speed of the casting belt 86 was at most 0.5% to the predetermined value. The position of the casting belt 86 in the widthwise direction was controlled with the detection of the positions of the side edges, such that meandering of the casting belt 86 running for one cycle was reduced in 1.5 mm. Further, below the casting die 89, the variation of the position in the vertical direction between the lip end of the casting die 89 and the casting belt 86 was in 200 μm. The casting belt 86 is preferably incorporated in the casting chamber 95 which has air pressure controller (not shown). The casting dope 22 was cast onto the casting belt 86 from the casting die 89.

(1-7) Casting & Drying

The temperature of the casting chamber 95 was kept to 35° C. At first, the drying air was fed out in parallel to the casting film 89 so as to make the drying. The overall heat transfer coefficient from the drying air to the casting film 89 was 24 kcal/(m²·hr·° C.). Further, the drying air at 135° C. was fed out from the upstream air blower 105 to dry the casting film 89, the drying air at 140° C. was fed out from the downstream air blower 106 to dry the casting film 89, and the drying air at 65° C. was fed out from the lower air blower 107 to dry the casting film 89. The saturation temperature of each drying air was about −8° C. Note that the oxygen concentration in the drying atmosphere on the casting belt 86 was kept to 5 volt by substituting the air for nitrogen gas. In order to keep the oxygen concentration to 5 volt, the inner air of the drying atmosphere was substituted by nitrogen gas. The solvent vapor in the casting chamber 95 was recovered by setting the temperature of exit of the condenser 98 to −10° C.

The air shielding plate 109 was disposed such that the drying air might not be applied to the casting film 89 and the bead directly for 5 seconds after the casting. The static pressure fluctuation near the casting die 89 was reduced to at most ±1 Pa. when the mass ratio of the solvent to the casting film 89 became 50 mass % on dry basis, the casting film 89 was peeled as the film 90 from the casting belt 86 with use of the peel roller 91. If the sample weight of the casting film 89 was x and the sample weight after the drying was y, the solvent content on the dry basis (%) was calculated in the formula, {(x−y)/y}×100. Note that in the content of the remaining solvent on dry basis, the weight of the solid obtained by completely drying the dope corresponds to 100%. Further, the peeling tension was 1×10² N/m². In order to reduce the peeling defects, the percentage of the peeling speed (the draw of the peel roller) to the speed of the casting belt 86 was controlled from 100.1% to 110%. The surface temperature of the film 90 was 15° C. The drying speed on the casting belt 86 was 60 mass %/min in average on dry basis. The solvent vapor generated in the evaporation is condensed by the condenser 98 at −10° C. to a liquid state, and recovered by the recovering device 101. The water content of the recovered solvent was adjusted to at most 0.5%. Further, the air from which the solvent components were removed was heated again and reused for the drying air. The film 90 was transported with the rollers in the transfer area 133 toward the tenter device 122. In the transfer area 133 the drying air at 40° C. is fed out from the air blower 134. Note that the tension about 30N was applied to the film 90 in the lengthwise direction of the rollers in the transfer area 133.

(1-8) Tenter Transportation, Drying. Edge Slitting

In the tenter device 122, while both side edge portions of the film 90 are held by clips, the stretch of the film 90 in the widthwise direction was made with the transportation. The transportation is made with chain, and the speed change of sprocket was at most 0.5% from a predetermined speed. The clips for the clipping in the tenter device 122 was cooled to 20° C. with use of a heat transfer medium. The gas concentration in the drying air was the saturated gas concentration at −10° C. The averaged drying speed (or solvent evaporation speed) in the tenter device 122 was 120 mass % on dry basis. The condition of each zone was controlled such that the content of the remaining solvent in the film 90 might be 7 mass % at the exit of the tenter device 122. If the percentage of the film width before the tenter device 122 was determined to 100%, the stretching ratio of the film width after the tenter device 122 was 110%. Further, the film 90 was drawn in the lengthwise direction between the peel roller 91 and the tenter device 122. The drawing ratio in percentage was 102%.

In the side edge portions in the tenter device 122, the ratio of the length variation between the clip starting position and the clip releasing position was made was 90%. The solvent vapor generated in the tenter device 122 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The film 90 was fed out as the film 90 from the tenter device 122.

In 30 seconds from exit of the tenter device 122, both side edge portions were slit off in the edge slitting device 123. In this experiment, each side portion of 50 mm in the widthwise direction of the film 90 was determined as the side edge portion, which were slit off by an NT type slitter of the edge slitting device 123. The slit side edge portions were sent to the crusher 132 by applying air blow from a blower (not shown), and crushed to tips about 80 mm². The tips were reused as raw material with the TAC frame for the dope production. The oxygen concentration in the drying atmosphere in the tenter device 122 was kept to 5 vol. %. Note that the air was substituted by nitrogen gas in order to keep the oxygen concentration at 5 vol. %. Before the drying at the high temperature in the drying chamber 127, the pre-heating of the film 90 was made in a pre-heating chamber (not shown) in which the air blow at 100° C. was supplied.

(1-9) Final Dry & Elimination

The film 90 was dried at high temperature in the drying chamber 127, which was partitioned into four partitions. Air blows whose temperatures were 120° C., 130° C., 130° C. and 130° C. from the upstream side were fed from air blowers (not shown) to the partitions. The transporting tension of each roller 111 to the film 90 was 100 N/m. The drying was made for ten minutes such that the content of the remaining solvent might be 0.3 mass % The lapping angle (center angle of contacting arc) of the roller 4 was 90° and 180°. The rollers 126 were made of aluminum or carbon steel. On the surface, the hard chrome coating was made. The surfaces of the rollers 126 were flat or processed by blast of matting process. The swing of the roller in the rotation was in 50 μm. Further, the bending of the roller 111 at the tension of 100N/m was reduced to at most 0.5 mm.

The solvent vapor contained in the drying air is removed with use of the recovering device 131 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The film 90 was transported to a first moisture controlling chamber (not shown). In a transport area between the drying chamber 127 and the first moisture controlling chamber, the drying air at 110° C. was fed. In the first moisture controlling chamber, the air whose temperature was 50° C. and dewing point was 20° C. was fed. Further, the film 90 was fed into a second moisture chamber (not shown) in which the curling of the film 90 was reduced. An air whose temperature was 90° C. and humidity was 70% was applied to the film 90 in the second moisture controlling chamber.

(1-10) Knurling, Winding Conditions

After the moisture adjustment, the film 90 was cooled to 30° C. in the cooling chamber 107, and then the edge slitting was performed. The compulsory neutralization device (or a neutralization bar) 113 was provided, such that in the transportation, the charged electrostatic potential of the film might be in the range of −3 kV to +3 kV. Further, the film knurling was made on a surface of each side of the film 90 by the knurling roller 114. The width of the knurling was 10 mm, and the knurling pressure was set such that the maximal thickness might be at most 12 μm larger in average than the averaged thickness.

The film 90 was transported to the winding chamber 143, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 90 was 80 μm in thick and 1475 mm in width. The diameter of the winding shaft 115 was 169 mm. The tension pattern was set such that the winding tension was a predetermined value. The film 90 was entirely 3940 m in length. The winding cycle was 400 m, and the oscillation width was in ±5 mm. Further, the pressure of the press roller 116 to the winding shaft 115 was set to a predetermined value. The temperature of the film at the winding was 25° C., the water content was 1.4 mass %, and the content of the remaining solvent was 0.3 mass %. The film production was continuously made for 3940 hours. Through all processes, according to the drying speed, 20 mass % of the solvent in dry weight standard was evaporated per minute in average. Further, the loose winding and wrinkles didn't occur, and the film didn't transit in the film roll even in 10 G impact test. Further, the roll appearance was good.

The film roll 21 was stored under the condition at 25° C. and 55% RH for one month. Furthermore, as result of inspecting in the same manner as above, the change having influence of the film quantity was not recognized. Furthermore there was any adhesion in the film roll 21. Further, after the film 90 was produced, part of the casting film 89 didn't remain on the casting belt 86 after the peeling.

(Estimation & Result)

The production of the film 90 was made for 1000 hours, and the evaluations of the film were made according to the occurrence of the stripe-like deformation of the produced film 90. The results of the evaluations are shown in Table 1, in which the grades A, B, N mean as follows:
A: there were no stripe-like deformations;
B: the film could be used although the stripe-like deformation was observed;
N: the film could not be used since stripe-like deformation occurred too much or extremely.

### EXAMPLE 2

In the casting belt 86, the depth maximum DE between the top and the bottom of the surface unevenness on the line P1P2 was 30 μm. Other conditions were the same as Example 1.

### EXAMPLE 3

The tension applied to the casting belt 86 in the running direction was 150 N/mm². Other conditions were the same as Example 1.

### EXAMPLE 4

The compressive residual stress of the casting belt 86 was 600 MPa. Other conditions were the same as Example 1.

### EXAMPLE 5

The tension applied to the casting belt 86 in the running direction was 250 N/mm². Other conditions were the same as Example 1.

### EXAMPLE 6

The depth maximum DE between the top and the bottom of the surface unevenness on the line P1P2 was 50 μm, the compressive residual stress of the casting belt 86 was 600 MPa and the tension applied to the casting belt 86 in the running direction was 150 N/mm². Other conditions were the same as Example 1.

TABLE 1

| Example | Evaluation |
|---|---|
| Example 1 | A |
| Example 2 | A |
| Example 3 | A |
| Example 4 | B |
| Example 5 | B |
| Example 6 | N |

As a result of the examples above, according to the casting surface 86a of the casting belt 86, if the depth maximum DE between the top and the bottom of the surface unevenness on the line P1P2 (L=10 mm) is at most 40 μm, the change of quality is reduced even in the use for a long time. Therefore, the stripe-like deformation of the produced film and other deformations can be reduced for a long time.

1. A solution casting apparatus comprising:
a casting die for casting a dope; and
a continuously running metal support having a casting surface, said cast dope forming a casting film on said casting surface, a depth DE between a top and a bottom of a surface unevenness of said casting surface being at most 40 μm between two points which are determined on said casting surface so as to be 10 mm apart in a widthwise direction of said metal support.

2. A solution casting apparatus claimed in claim 1, wherein a compressive residual stress of said metal support is at most 500 MPa.

3. A solution casting apparatus claimed in claim 2, wherein said metal support is an endless belt.

4. A solution casting apparatus claimed in claim 3, further comprising:
a pair of back-up rollers for supporting said endless belt, said endless belt circulatory running in accordance with rotation of at least one of said back-up rollers; and
a shift device for shifting at least one of said back-up rollers so as to control a tension of said endless belt in said running direction.

5. A solution casting apparatus claimed in claim 4, wherein said tension of said endless belt is in the range of 50 N/mm² to 200 N/mm².

6. A solution casting apparatus claimed in claim 5, wherein said endless belt is produced of stainless steel.

7. A solution casting apparatus claimed in claim 6, wherein the annealing is performed to said endless belt.

8. A solution casting method comprising steps of:
continuously running a metal support;
casting a dope from a casting die on a casting surface of said metal support so as to form a casting film; and
peeling from said metal support said casting film as a film by a peel roller;
wherein when two points apart from 10 mm in a widthwise direction of said metal support is determined on said casting surface of said metal support, a depth maximum DE between a top and a bottom of a surface unevenness of said casting surface is at most 40 μm between said two points.

9. A solution casting method claimed in claim 8, wherein a compressive residual stress of said metal support is at most 500 MPa.

10. A solution casting method claimed in claim 8, wherein said metal support is an endless belt supported by a pair of back-up rollers, and said endless belt circulatory runs in accordance with rotation of said back-up rollers.

11. A solution casting method claimed in claim 10, further comprising shifting at least one of said back-up rollers by a shift device so as to control a tension of said endless belt in said running direction.

12. A solution casting method claimed in claim 11, wherein said tension of said endless belt is in the range of 50 N/mm² to 200 N/mm².

13. A solution casting method claimed in claim 12, wherein said endless belt is produced of stainless steel.

14. A solution casting method claimed in claim 13, wherein the annealing is performed to said endless belt.
